(19) United States
(12) Patent Application Publication
(10) Pub. No.: US 2007/0092281 A1
(43) Pub. Date: Apr. 26, 2007

(54) Image forming device

(76) Inventor: Yasushi Saito, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,083

(22) Filed: Oct. 26, 2005

(51) Int. Cl. G03G 21/02

(52) U.S. Cl. 399/79

(57) ABSTRACT

The device of the invention comprises an advertisement image storage unit 32 for storing a plurality of advertisement images (add-on images) and the discount rate predefined for each of the advertisement images, a display control unit 22 for generating a list image listing the discount rate for each advertisement image and causing the display unit 12 to display the list image, an operation unit 13 for receiving a selection directive for the advertisement image from the user based on the list image, and a printing control unit 25 for composing the selected advertisement image into the document image and causing the printing unit 15 to print the composed image.

### FIELD OF THE INVENTION

The present invention relates to an image forming device that collects a fee from a user and prints a document image on recording paper.

### BACKGROUND INFORMATION

In recent years, advances have been made in advertised copying services for convenience stores and the like, in which a predetermined advertisement image (add-on image) is added when making prints on recording paper to allow for discounts on copying fees. Then, such copying services include those in which an advertisement image to be printed on the recording paper is selected from among a plurality of types of advertisement images by the user, and the discount rate is changed according to the type of advertisement image selected.

Among conventional image processing devices, there is a device in which copying fees that are preset for a plurality of advertisement images are displayed on a liquid crystal display screen, the user selects a copying fee from among a plurality of copying fees displayed, and corresponding to the selected copying fee, for each recording paper size, a preview of the image showing the region that will be occupied on the recording paper by the advertisement image is displayed to let the user select the preferred recording paper size.

However, although this device can make it easy to select a recording paper size based on the region on the recording paper that will be occupied by the advertisement image, it is difficult to select an advertisement image to be printed onto the recording paper from among a plurality of advertisement images based on the discount rate for each advertisement image.

An object of the present invention is to provide an image forming device which allows the user to easily select an add-on image to be printed on recording paper from among a plurality of add-on images based on the discount rates for the add-on images.

### SUMMARY OF THE INVENTION

The image forming device according to the present invention is an image forming device that collects printing fees and prints a document image on recording paper, comprising a storage means for storing a plurality of add-on images to be printed together with the document image and a discount rate predefined for each of the add-on images, a display means for displaying a list image that displays in a list the discount rates for the add-on images, a receiving means for receiving an add-on image selection directive from the user, a fee calculation means for calculating the printing fee based on the discount rate received by the receiving means, and a printing means for composing and printing onto the recording paper the add-on image indicated by the selection directive and the document image.

In addition, it is preferred that the above constitution further comprise an extraction means for extracting as a blank region a continuous region within the document image where a background portion of no less than a predetermined size is present, and extracting, based on the sizes of the plurality of add-on images stored on the storage means and the size of the blank region, an add-on image that can be displayed within the blank region, the display means displaying on the list image the discount rates for the add-on images extracted by the extraction means, and the printing means composing in the blank region the add-on image indicated by the selection directive received by the receiving means.

In addition, it is preferred that the above constitution further comprise a printing mode determination means for determining a printing mode of the add-on image onto the recording paper by allowing the user to specify an item condition for each of a predetermined plurality printing items, the storage means pre-storing the discount rate for each item condition of each add-on image, and the above constitution further comprising a discount rate calculation means for specifying the discount rate for the item condition specified by the user by referring to the storage means and calculating a discount rate for each add-on image based on the specified discount rate, and the printing means printing the add-on image onto the recording paper with the printing mode determined by the printing mode determination means.

In addition, it is preferred, in the above constitution, that the printing items include an item for setting the size of the add-on image, and the extraction means extracts, based on the size of each add-on image determined by the printing mode determination means and the size of the blank region, an add-on image that can be displayed within the blank region.

In addition, preferably in the above constitution, the printing items include color, size, orientation, number and position.

In addition, it is preferred in the above constitution that the storage means further store a weighting coefficient predefined for each of the printing items, and that the discount rate calculation means calculate the discount rate for each add-on image by multiplying the weighting coefficient by the discount rate for each item condition.

In addition, it is preferred in the above constitution that the display means displays the list image listing the ratio of the discount rate of each add-on image with respect to the maximum discount rate of the add-on image.

According to the invention recited in claim 1, a discount rate predefined for each of a plurality of add-on images to be printed attached to a document image is displayed in a list, an add-on image to be printed onto the recording paper is selected based on the discount rate displayed in the list, a printing fee is calculated based on the discount rate for the selected add-on image, the selected add-on image is composed onto the document image and printed onto the recording paper; thus, the user can easily select, based on the discount rates displayed in the list, an add-on image to be printed onto recording paper. Here, the discount rates, for instance, may be displayed together with the corresponding add-on images in a list, or may be displayed together with names specifying the corresponding add-on images in a list.

According to the invention recited in claim 2, add-on images that can be displayed within a blank region of a document are displayed in a list in an list image; this makes it possible to avoid both overlaying the add-on image over the content of the document image and clipping the add-on image.

According to the invention recited in claim 3, the printing mode for an add-on image is determined by the item condition for each printing item specified by the user, the discount rate is calculated for each add-on image based on a discount rate predefined for each item condition, and the calculated discount rates are displayed in a list in a list image; thus, the user can set the add-on image to the desired printing mode with consideration for the discount rate for the add-on image.

According to the invention recited in claim 4, even if the size of the add-on image is changed, printing of the add-on image overlaid over the content of the document image and clipping the add-on image can be avoided.

According to the invention recited in claim 5, the user can set the color, size, orientation, number, and position of the add-on image, so as to select a lower copying fee.

According to the invention recited in claim 6, the discount rate is calculated by multiplying a discount rate for each set item condition by a weighting coefficient predefined for each of the printing items.

According to the invention recited in claim 7, the ratio of the discount rate of each add-on image with respect to the discount rate of the add-on image with the maximum discount rate is displayed in a list in the list image; thus, selection of an add-on image based on the discount rate can be performed more easily.

### BRIEF DESCRIPTION OF THE DRAWINGS

FIG. 1 is a schematic side view principally showing the mechanical constitution of the image forming device according to the present invention as applied to a copier.

FIG. 2 is a block diagram showing the functional constitution of the present copier according to a first embodiment of the present invention.

FIG. 3 is a flowchart showing the operation of the copier in the first embodiment.

FIG. 4 is a view showing one example of list image displayed on the display unit.

FIG. 5 is a block diagram showing the functional constitution of a copier according to a second embodiment.

FIG. 6 is a schematic view showing a discount rate table.

FIG. 7 is a flowchart showing the operation of the copier according to the second embodiment.

FIG. 8A and FIG. 8B are views showing examples of operation images shown on the display unit in the second embodiment.

FIG. 9 is a schematic view showing the data structure of a weight coefficient table.

### DETAILED DESCRIPTION OF THE PREFERRED EMBODIMENTS

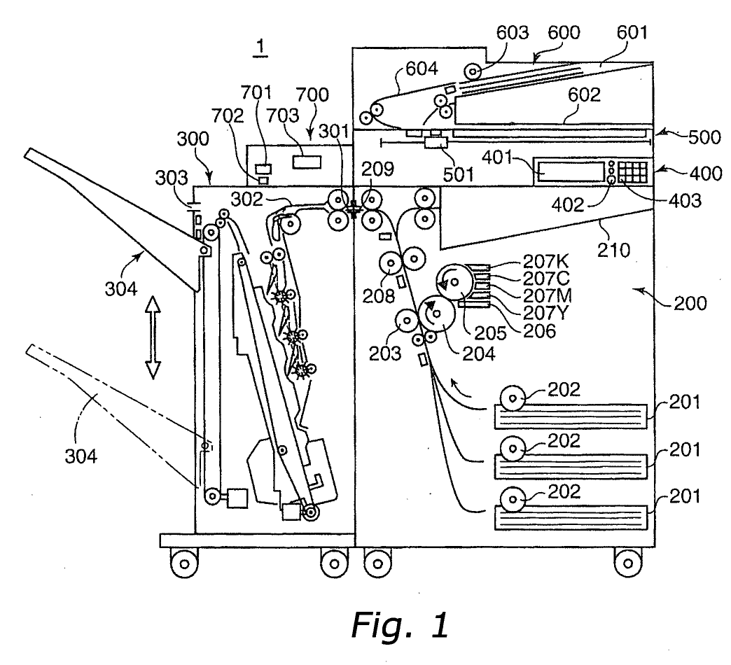

Hereinafter, the modes of the embodiment of the present invention will be described with reference to the drawings. FIG. 1 is a schematic side view principally showing the mechanical constitution of the image forming device according to the present invention as applied to a copier. It should be noted that the present copier is located in stores that provide a copying service to users, such as convenience stores and stationery shops. The present copier is comprises a main body unit 200, a sheet after-processing unit 300 disposed on the left side of the main body unit 200, an operation unit 400 through which the user enters various operation directives or the like, a document reading unit 500 disposed on top of the main body unit 200, a document feeding unit 600 disposed above the document reading unit 500, and a fee payment device 700 through which the user pays a copying fee.

The operation unit 400 comprises a control panel 401, a start key 402 and a numeric keypad 403, and the like. The control panel 401 displays various operation screens while at the same time displays various operation buttons or the like to be used by the user to enter various operation directives. The start key 402 is used by the user to enter a printing operation directive or the like, and the numeric keypad 403 is used to enter the number of copies or the like.

The document feeding unit 600 comprises a document loading unit 601, a document output unit 602, a paper feeding roller 603, a document transport unit 604 and the like, and the document reading unit 500 comprises a scanner 501 or the like. The paper feeding roller 603 pulls out documents set on the document loading unit 601, and the document transport unit 604 sequentially transports the pulled out documents, sheet by sheet, onto the scanner 501. The scanner 501 sequentially reads the transported documents, and the read documents are output to the document output unit 602.

The main body unit 200 comprises a plurality of paper feeding cassettes 201, a plurality of paper feeding rollers 202, a transfer roller 203, an intermediate transfer roller 204, a photosensitive drum 205, an exposure device 206, development devices 207Y, 207M, 207C and 207K for the colors of yellow, magenta, cyan and black, respectively, a fixing roller 208, an output opening 209, and an output tray 210 or the like.

The photosensitive drum 205 is uniformly charged by a charging device (omitted from figure) while rotating in the direction indicated by the arrow. The exposure device 206 converts a modulation signal which has been generated based on the image data of the document read by the document reading unit 500, into a laser beam and outputs the beam to form, on the photosensitive drum 205, separate electrostatic latent images for different colors. The development devices 207Y, 207M, 207C and 207K supply a developer for each color to the photosensitive drum 205 to form a separate toner image for each color.

A toner image of each color is transferred from the photosensitive drum 205 to the intermediate transfer roller 204, and a color toner image is formed on the intermediate transfer roller 204.

Meanwhile, the feed roller 202 pulls out the recording paper from the paper feeding cassette 201 where the recording paper is stored, and transports the paper to the transfer roller 203. The transfer roller 203 transfers the toner image on the intermediate transfer roller 204 onto the transported recording paper, and the fixing roller 208 heats and fixes the transferred toner image onto the recording paper. Thereafter, the recording paper is transported from the output opening 209 of the main body unit 200 to the sheet after-processing unit 300. In addition, the recording paper is also delivered onto the output tray 210, as necessary.

The sheet after-processing unit 300 comprises an in-feed opening 301, a recording paper transport unit 302, an out-feed opening 303 and a stacking tray 304, and the like. The recording paper transport unit 302 sequentially transports the recording paper fed through the output opening 209 to the in-feed opening 301, eventually delivers the recording paper through the out-feed opening 303 to the stacking tray 304. The stacking tray 304 is constituted to be vertically movable in the arrow direction according to the number of stacked sheets of recording paper which have been delivered from the out-feed opening 303.

The fee payment device 700 comprises a bill insertion opening 701 through which a bill is inserted by a user, a coin insertion opening 702 through which a coin is inserted by a user, and a display unit 703 for displaying the inserted amount, and the like.

### First Mode of Embodiment

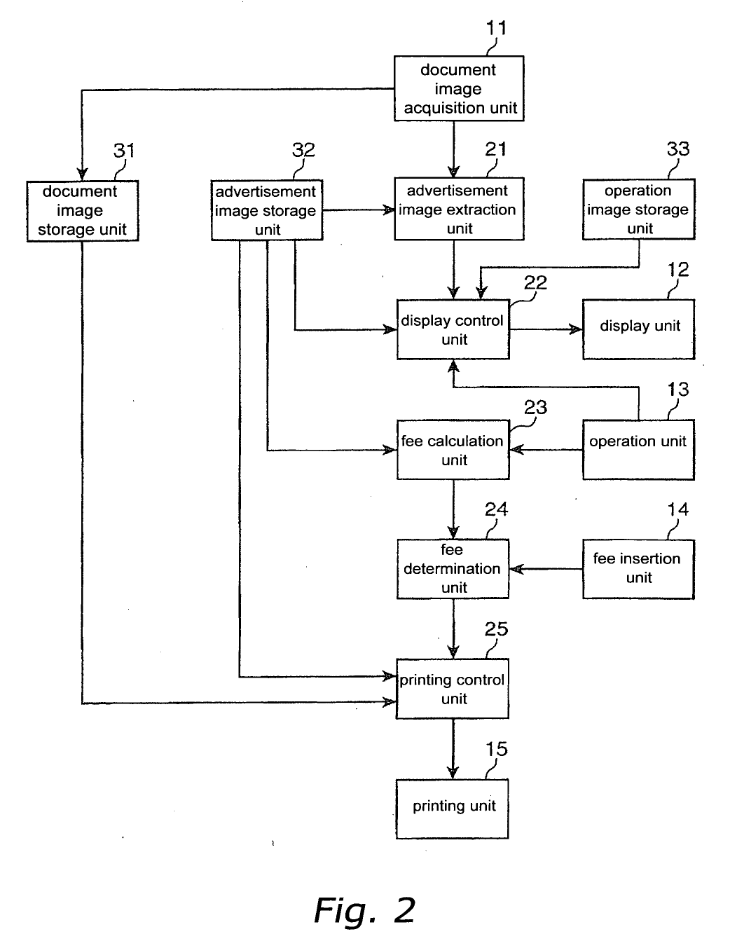

FIG. 2 is a block diagram showing the functional constitution of the present copier according to the first mode of embodiment of the present invention. This copier comprises a document image acquisition unit 11, a display unit 12, an operation unit 13, a fee insertion unit 14, a printing unit 15, an advertisement image extraction unit 21, a display control unit 22, a fee calculation unit 23, a fee determination unit 24, a printing control unit 25, a document image storage unit 31, an advertisement image storage unit 32 and an operation image storage unit 33. The advertisement image extraction unit 21 through the printing control unit 25 are constituted by a CPU or the like, and the document image storage unit 31 through the operation image storage unit 33 are constituted by a hard disk, RAM (random access memory) or the like.

The document image acquisition unit 11 comprises the image reading unit 500 shown in FIG. 1 and reads the document optically to acquire the image of the document (hereinafter referred to as document image), and causes the document image storage unit 31 to store the image. The display unit 12 comprises the control panel 401 shown in FIG. 1, and displays various images under the control of the display control unit 22. The operation unit 13 comprises the operation unit 400 shown in FIG. 1.

The fee insertion unit 14 comprises the fee payment device 700 shown in FIG. 1, distinguishes the types of paper currency and coins inserted by the user, and calculates the copying fee paid by the user. The printing unit 15 comprises the transfer roller 203, the intermediate transfer roller 204, the photosensitive drum 205, the exposure device 206, the development devices 207Y, 207M, 207C and 207K, and the fixing roller 208 shown in FIG. 1, and prints the output image generated by the printing control unit 25 onto recording paper.

The document image storage unit 31 stores the document image acquired by the document image acquisition unit 11. The advertisement image storage unit 32 stores a plurality of types of advertisement images and the discount rates predefined for different advertisement images. The operation image storage unit 33 stores various operation images that are to be displayed on the display unit 12 when the user enters various operation directives to the present copier.

The advertisement image extraction unit 21 extracts the blank region in the document image acquired by the document image acquisition unit 11 and specifies an advertisement image that can be displayed within the extracted blank region, based on the size of the blank region and the size of each of the advertisement images stored in the advertisement image storage unit 32. Here, a blank region indicates a continuous region within a document image where a background portion of the document is continuously present of at least a predetermined size is present.

The display control unit 22 generates a list image that associates and displays the advertisement image extracted by the advertisement image extraction unit 21 and the corresponding discount rate and causes the display unit 12 to display the list image. In addition, the display control unit 22 causes the display unit 12 to display various operation images stored by the operation image storage unit 33. Furthermore, the display control unit 22 causes the display unit 12 to display various data entered through the operation unit 13 by the user.

The fee calculation unit 23 reads, from the advertisement image storage unit 32, the discount rate for the advertisement image selected through the operation unit 13 by the user, and calculates the copying fee from the read discount rate, a predefined copying fee per document, and the number of documents read by the document image acquisition unit 11.

The fee determination unit 24 determines whether or not the copying fee paid by the user through the fee insertion unit 14 exceeds the copying fee calculated by the fee calculation unit 23, and if it does exceed this, the fee determination unit 24 sends a control signal to the printing control unit 25 to generate an output image.

The printing control unit 25, when receiving the control signal from the fee determination unit 24, reads the document image from the image storage unit 31, while at the same time the printing control unit 25 reads the advertisement image selected by the user, from the advertisement image storage unit 32, and composes the read advertisement image in the blank region of the document image to generate the output image.

In the present mode of embodiment, the advertisement image storage unit 32 corresponds to an example of storage means, the advertisement image extraction unit 21 corresponds to an example of extraction means, the display control unit 22 and the display unit 12 correspond to an example of display means, the operation unit 13 corresponds to an example of receiving means, the fee calculation unit 24 corresponds to an example of fee calculation means, and the printing control unit 25 and the printing unit 15 correspond to an example of printing means.

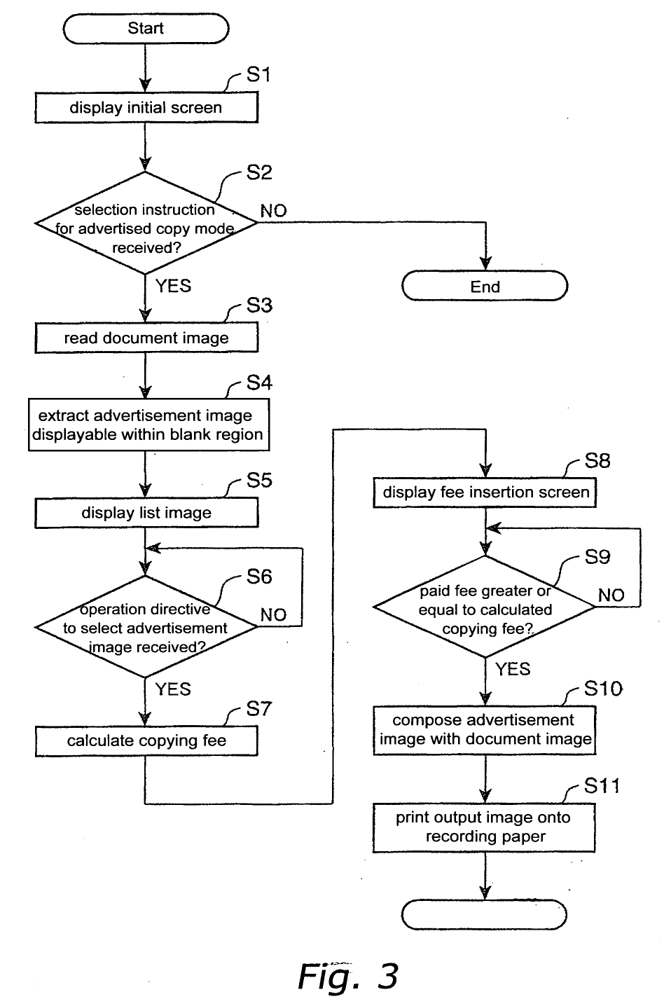

FIG. 3 is a flowchart showing the operation of the copier of the first mode of embodiment. Hereinafter, execution of the first mode of embodiment by the copier will be described according to the flowchart shown in FIG. 3. First, in step S1, the display control unit 22 reads from the operation image storage unit 33 an initial image to be used by the user to select an advertised copying mode, and causes the display unit 12 to display the image.

In step S2, if the operation unit 13 receives from the user an operation directive to select the advertised copying mode (YES in S2), the process advances to step S3, and if the operation unit 13 receives from the user an operation directive not to select the advertised copying mode (NO in S2), the process is terminated.

In step S3, the document image acquisition unit 11 optically reads the document placed on the document loading unit 601 and acquires the document image, and causes the document image storage unit 31 to store the image. Here, if a plurality of documents have been placed on the document loading unit 601, document images corresponding to the plurality of documents placed are acquired. The plurality of document images are grouped as one job and stored by the document image storage unit 31.

In step S4, the advertisement image extraction unit 21 extracts the blank region of the document image acquired by the document image acquisition unit 11, and extracts an advertisement image having a size that allows the image to be displayed within the extracted blank region, as a printable advertisement image from a plurality of advertisement images stored by the advertisement image storage unit 32. Here, if a plurality of document images are present in one job, a blank region is extracted for each of the document images, and advertisement images having sizes that allows the images to be displayed in the blank regions of all the document images are extracted as printable advertisement images.

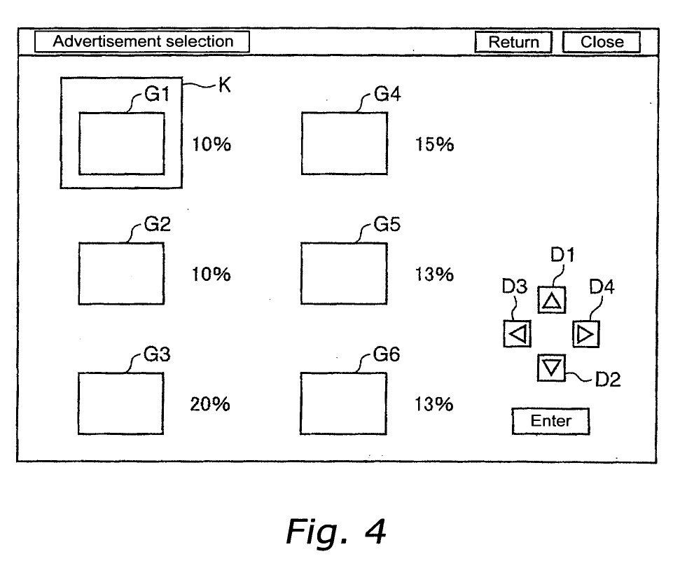

In step S5, the display control unit 22 forms a list image that displays the extracted advertisement image and the corresponding discount rate in connection with each other, and causes the display unit 12 to display the image. FIG. 4 is a view showing one example of list image displayed on the display unit 12. In the list image shown in FIG. 4, six advertisement images G1 to G6 are displayed in three rows and two columns, and the discount rate of the corresponding advertisement image is displayed as a percent on the right side of each advertisement image. In this way, the user can check at a glance the content of the advertisement image and the discount rate for the advertisement image.

In step S6, if the operation unit 13 receives a selection directive for an advertisement image by the user (YES in S6), the process advances to step S7, and if the operation unit 13 does not receive a selection directive for an advertisement image by the user (NO in S6), the process returns to step S6. Here, if any of the four arrow buttons D1 to D4, up, down, left and right, displayed on the right center portion of the list image shown in FIG. 4 is pushed by the user, the display control unit 22 moves rectangular cursor K so as to surround the periphery of an advertisement image, in the direction indicated by the pushed arrow button D1 to D4. In addition, when the “ENTER” button is pressed by the user, the operation unit 13 receives the advertisement image where the cursor K is positioned as the advertisement image selected by the user.

That is to say, the user presses the arrow buttons D1 to D4 to move the cursor K to the position where the desired advertisement image is displayed, and presses the “ENTER” button to select the advertisement image to be printed onto the recording paper.

In step S7, the fee calculation unit 23 multiplies the number of document images by the copying fee per document, and multiplies the multiplied value by the discount rate of the advertisement image selected by the user to calculate the copying fee of the job.

In step S8, the display control unit 22 causes the display unit 12 to display an image to inform the user of the copying fee. In step S9, the fee determination unit 24 compares the copying fee paid by the user through the fee insertion unit 14 with the copying fee calculated by the fee calculation unit 23; if the copying fee that has been paid is determined to be greater or equal to the calculated copying fee (YES in S9), the process advances to step S10, and if the copying fee that has been paid is determined to be less than the calculated copying fee (NO in S9), the process returns to step S9.

In step S10, the printing control unit 25 composes the advertisement image selected by the user in the blank region of the document image, and generates the output image. In step S11, the printing unit 15 prints the output image generated by the printing control unit 25 onto the recording paper.

### Second Mode of Embodiment

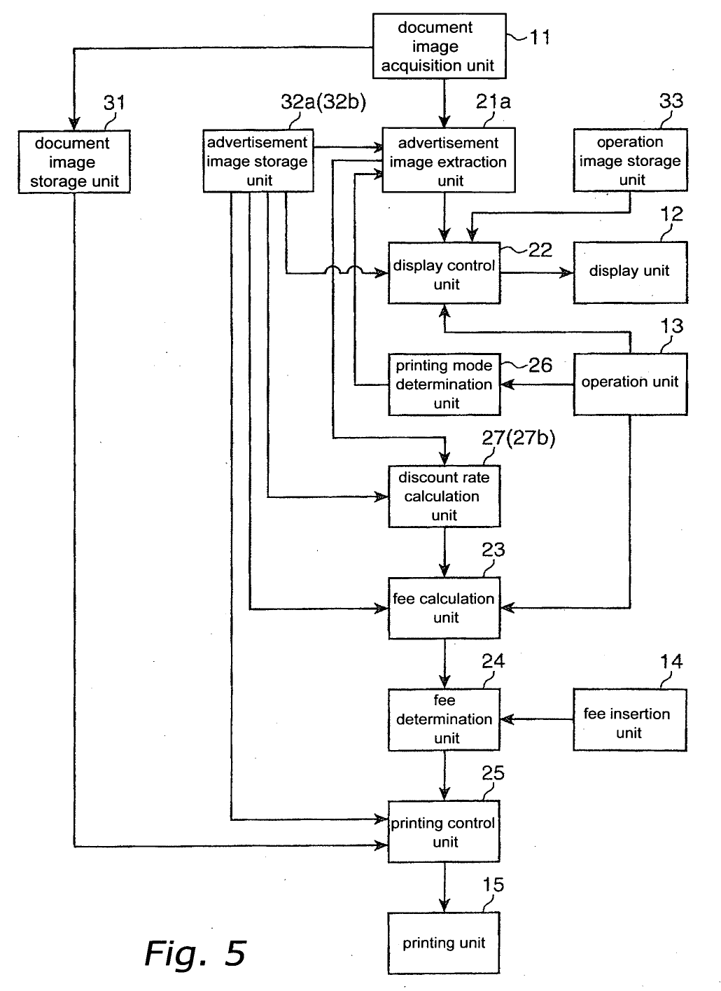

Next, the copier of the second mode of embodiment will be described. The copier of the second mode of embodiment is provided, in addition to the functions of the copier of the first embodiment, with a function which allows the user to adjust the size or the like of the advertisement image and varies the discount rates accordingly. FIG. 5 shows a block diagram showing the functional constitution of a copier according to the second mode of embodiment. It should be noted that the same reference numerals are assigned to the same blocks as in the copier of the first mode of embodiment, and description thereof will be omitted.

Compared to the first mode of embodiment, the copier of the second mode of embodiment further comprises a printing mode determination unit 26 and a discount rate calculation unit 27, and the memory content for the advertisement image storage unit 32a and the function of the advertisement image extraction unit 21a are different from those of the first mode of embodiment.

The printing mode determination unit 26 determines, based on the item conditions of the printing items entered by the user through the operation unit 13, the printing mode of the advertisement image to be printed onto the recording paper. In the present mode of embodiment, printing items include color, number of images, orientation, size and position. The printing item for color is a printing item for defining the color of the advertisement image to be printed onto the recording paper, and includes the item conditions such as “color” for color-printing the advertisement image and “monochrome” for printing the advertisement image in black, in the present mode of embodiment.

The printing item for number is an item for setting the number of advertisement images to be printed onto one sheet of recording paper, and the numerical value defining the number of advertisement images is an item condition in the present mode of embodiment. The printing item for orientation is an item for setting the printing direction of the advertisement image, and includes the item conditions such as vertical for printing the advertisement image in the portrait orientation, and horizontal for printing the advertisement image in the landscape orientation, in the present mode of embodiment.

The printing item for size is an item for setting the size of the advertisement image to be printed onto the recording paper and includes three item conditions, large, medium and small, in the present mode of embodiment. The printing item for position is an item for setting the position of the advertisement image to be printed onto the recording paper and includes the item conditions such as top for printing the advertisement image in the blank region at the top of the recording paper, bottom for printing the advertisement image in the blank region at the bottom of the recording paper, left for printing the advertisement image in the blank region on the left side of the recording paper, and right for printing the advertisement image in the blank region on the right side of the recording paper, in the present mode of embodiment.

In addition to the functions of the advertisement image extraction unit 21 of the first mode of embodiment, the advertisement image extraction unit 21a edits each advertisement image stored in the advertisement image storage unit 32 according to the printing mode determined by the printing mode determination unit 26, and extracts, as a printable advertisement image among the edited advertisement images, an advertisement image having a size that can be displayed within the blank region of the document image.

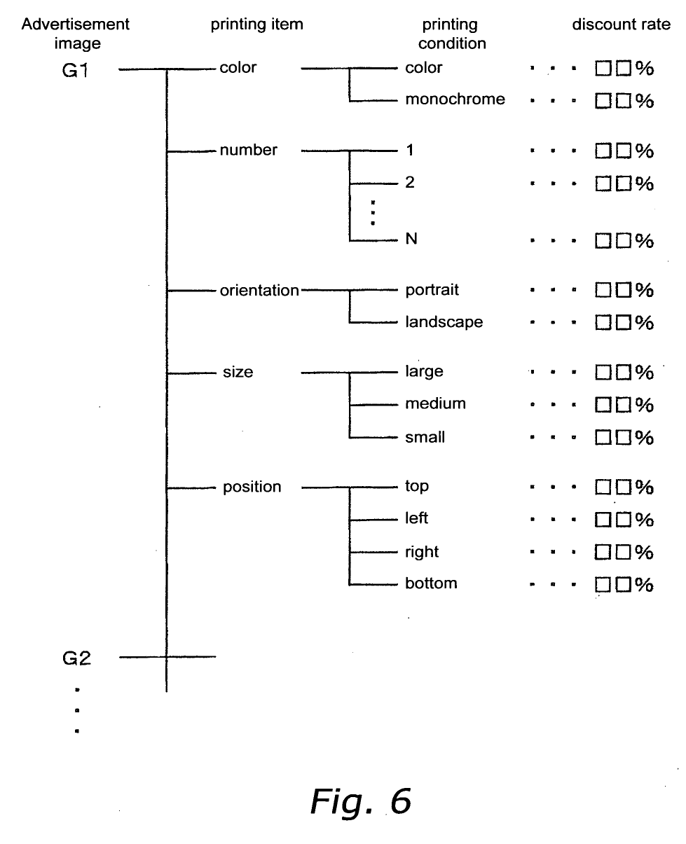

In addition to the data stored by the advertisement image storage unit 32, the advertisement image storage unit 32a further stores a discount rate table that stores the discount rate predefined for each item condition of each advertisement image. It should be noted that the discount rate predefined for each advertisement image stored by the advertisement image storage unit 32a serves as a default discount rate for the advertisement image before the printing mode is modified. FIG. 6 is a schematic view showing a discount rate table. As shown in FIG. 6, the discount rate table comprises fields for advertisement images, printing items, item conditions and discount rates. A number N of pre-stored advertisement images G1 to GN are listed in the advertisement image field. Item conditions consisting of colors, number of items, orientations, sizes and positions are listed in the printing item field for each of the advertisement images G1 to GN. Item conditions for each of the printing items are listed in the item condition field. The discount rates for item conditions are listed in the discount rate field.

The discount rate calculation unit 27 refers to the discount rate table to specify the discount rate for each item condition indicated by the printing mode determined by the printing mode determination unit 26, and calculates the discount rate for each advertisement image extracted by the advertisement image extraction unit 21a.

In the present mode of embodiment, the advertisement image storage unit 32a corresponds to one example of storage means, the display control unit 22 and the display unit 12 correspond to one example of display means, the operation unit 13 corresponds to one example of receiving means, the advertisement image extraction unit 21a corresponds to one example of extraction means, the discount rate calculation unit 27 corresponds to one example of discount rate calculation means, the fee calculation unit 24 corresponds to one example of fee calculation means, the printing control unit 25 and the printing unit 15 correspond to one example of printing means.

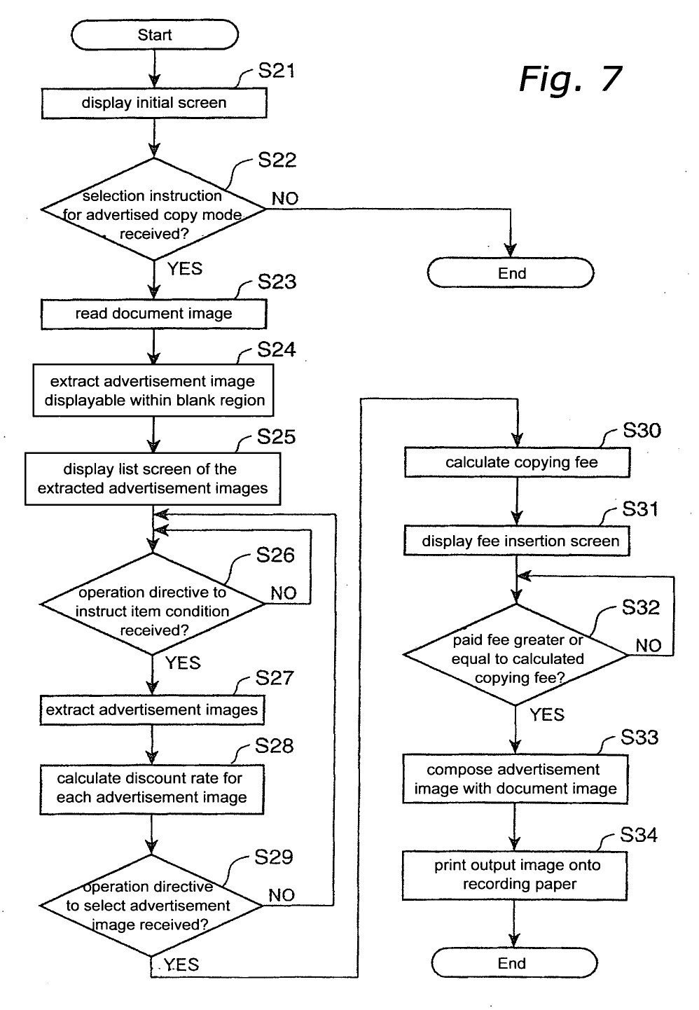

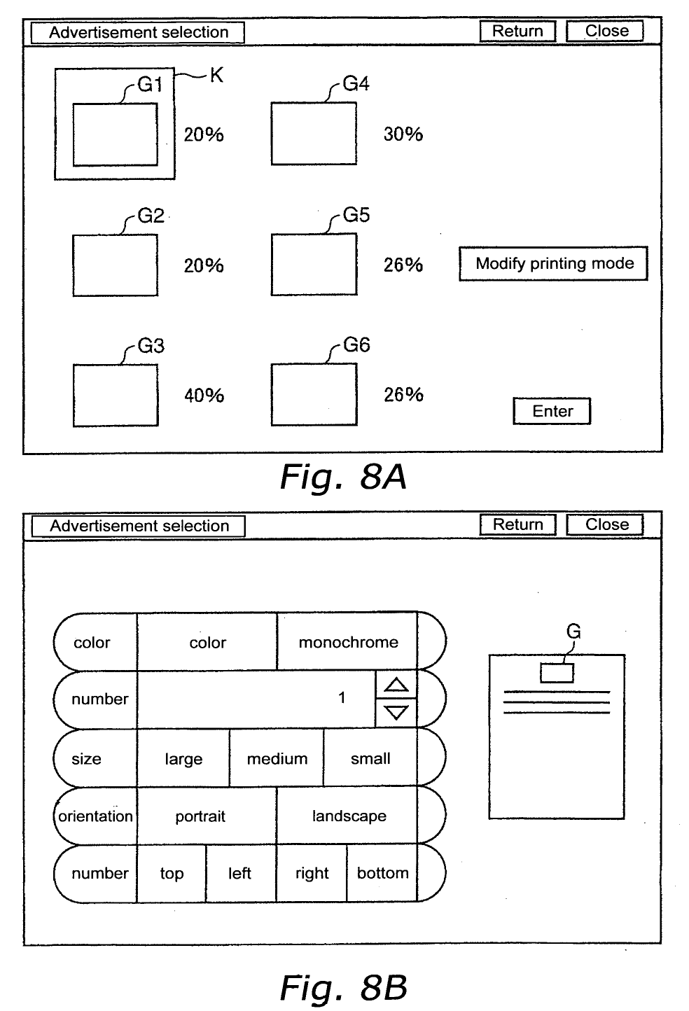

FIG. 7 is a flowchart showing the operation of the copier according to the second mode of embodiment. Hereinafter, operation of the copier according to the second mode of embodiment will be described according to the flowchart shown in FIG. 7. As the processes of steps S21 to S24 are identical to the processes of steps S1 to S4 shown in FIG. 3, description thereof is omitted. In step S25, the display control unit 22 generates a list image that associates and displays the advertisement images extracted by the advertisement image extraction unit 21a, and the default discount rates for the each advertisement images, and causes the display unit 12 to display the image. In this case, a list image such as shown in FIG. 8A is displayed on the display unit 12. If the “modify printing mode” button displayed on the right side of the list image shown in FIG. 8A is pressed, the display control unit 22 reads from the operation image storage unit 33 an image for setting the printing mode shown in FIG. 8B and causes the display unit 12 to display the image.

In step S26, if the operation unit 13 receives from the user an operation directive for specifying an item condition via the operation unit 13 (YES in S26), the process advances to step S27, and if an operation directive for specifying an item condition is not received (NO in S26), the process returns to step S26.

As shown in FIG. 8B, fields corresponding to the printing items for colors, number of items, sizes, orientations and positions are displayed in the image for setting the printing mode. “Color” and “monochrome” buttons are displayed in the setting field for the printing item for color, and the user presses either one of the buttons to set the item condition for the printing item for color. A numerical value display field is displayed in the setting field for the printing item for number, and when the user presses the numeric keypad or the up/down arrow buttons displayed on the right side of the field, a number is displayed in the numerical value display field, and the number of advertisement images to be printed is set to this number.

Three buttons, i.e., “large”, “medium” and “small”, are displayed in the setting field for the printing item for size, and the user pushes any one of these buttons to set the size of the advertisement image. Two buttons, i.e., “portrait” and “landscape”, are displayed in the setting field for the printing item for orientation, and the user presses either one of the buttons to set whether to print the advertisement image in the portrait orientation or landscape orientation. Four buttons, i.e., “top”, “left”, “right” and “bottom”, are displayed in the setting field for the printing item for position, and the user presses any one of the buttons to set the display position of the advertisement image.

In addition, a field for displaying the setting status of an advertisement image G as a preview is provided on the right side of the image shown in FIG. 8B. The display control unit 22 modifies and displays the advertisement image G displayed as a preview according to the setting content each time the setting of the printing mode is modified, and thus allows the user to set the printing mode while looking at the advertisement image G displayed as a preview.

In step S27, the advertisement image extraction unit 21a specifies the size of each advertisement image according to the item condition specified by the user, and extracts an advertisement image that can be displayed within the blank region as a printable advertisement image, based on the specified size of each advertisement image and the size of the blank region of the document image.

In step S28, the discount rate calculation unit 27 refers to the discount rate table to calculate the discount rate for each of the advertisement images extracted in step S27. Here, the discount rate calculation unit 27 specifies the discount rate for the item condition set for each of the printing items for color, number of images, size, orientation and position, by referring to the discount rate table, and calculates the discount rate for each advertisement image, for instance, by adding the specified discount rates.

In addition, if the user presses the “return” button displayed on the upper side of the image in FIG. 8B, the display control unit 22 causes the display unit 12 to display the list image shown in FIG. 8A. In this case, the discount rate after the modification of the printing mode calculated by the discount rate calculation unit 27 is displayed on the right side of each advertisement image. In this way, the user can rapidly check the discount rate for each advertisement image in the printing mode set by the user.

In step S29, if the operation unit 13 receives an operation directive by the user to select an advertisement image to be printed onto the recording paper (YES in S29), the process advances to step S30, and an operation directive to select an advertisement image is not received (NO in S29), the process returns to step S26.

In step S30, the fee calculation unit 23 multiplies the number of document images by the copying fee per document, and multiplies the multiplied value by the discount rate for the advertisement image selected by the user to calculate the copying fee for one job.

In step S31, the display control unit 22 causes the display unit 12 to display an image to inform the user of the copying fee. In step S32, the fee determination unit 24 compares the copying fee paid by the user through the fee insertion unit 14 with the copying fee calculated by the fee calculation unit 23; if the copying fee that has been paid is determined to be greater or equal to the calculated copying fee (YES in S32), the process advances to step S33, and if the copying fee that has been paid is determined to be less than the calculated copying fee (NO in S32), the process returns to step S32.

In step 533, the printing control unit 25 composes the advertisement image selected by the user in the blank region of the document image, and generates the output image. In step S34, the printing unit 15 prints the output image generated by the printing control unit 25 onto the recording paper.

### Third Embodiment

The third mode of embodiment calculates the discount rate for a combination pattern of printing items which are set after modifying the default item conditions, based on a weighting coefficient predefined for each printing item comprised by the pattern. As the third mode of embodiment is constituted on the basis of the second mode of embodiment, only the parts that differ from the second mode of embodiment will be described.

In the third mode of embodiment, in addition to the data stored by the advertisement image storage unit 32a of the second mode of embodiment, an advertisement image storage unit 32b shown in FIG. 5 further stores a weight table that stores, for each combination pattern of printing items, the weighting coefficient for the printing items constituting each pattern.

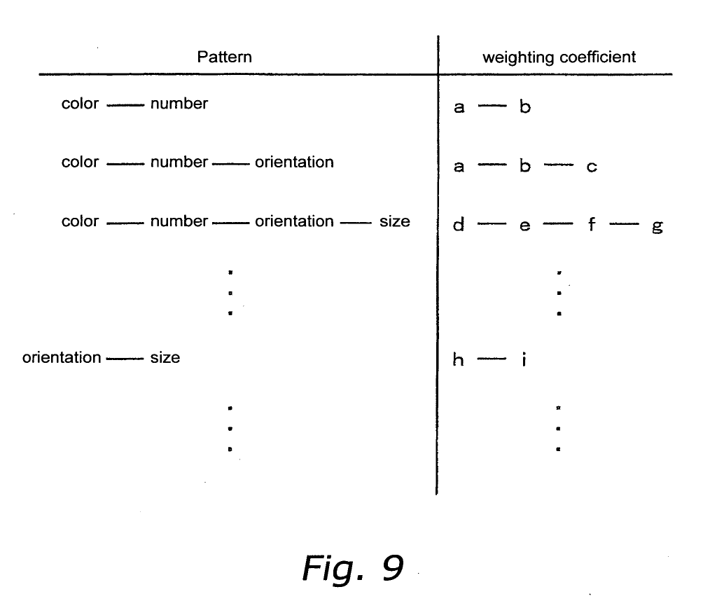

FIG. 9 is a schematic view showing the data structure of a weight coefficient table. As shown in FIG. 9, the weighting coefficient table comprises a pattern column and a weighting coefficient column. Combinations of printing items which have been modified from the default item conditions are listed in the pattern column. The weighting coefficients of the printing items that constitute each pattern are listed in the weighting coefficient column.

For instance, in the first row, color-number is listed in the pattern column, and a-b is listed in the weighting coefficient column, and in such a pattern, the weighting coefficient of the printing item for color is a, and the weighting coefficient of the printing item for number of images is b. In addition, in the third row, color-number-orientation-size is listed in the pattern column, and d-e-f-g is listed in the weighting coefficient column, and in such a pattern, the weighting coefficient of each of the printing items for color, number of images, orientation and size is d, e, f, and g, respectively.

The discount rate calculation unit 27b calculates the discount rate according to, for instance, Formula 1.
Σᵢαᵢ.xᵢ+Σⱼxⱼ Formula (1)
It should be noted that, αᵢ represents the weighting coefficient for the i^{th} printing item, xᵢ represents the discount rate for the i^{th} printing item, i represents a number for specifying the printing item in which the setting has been modified from the default item condition, xⱼ represents the discount rate for the j^{th} printing item, j represents a number for specifying the printing item in which the setting is not modified from the default item condition.

As described above, according to the copiers of the first to the third modes of embodiment, a list image is displayed, which displays, in a list, advertisement images that can be printed in the blank region of the recording paper and the discount rates corresponding to the advertisement images; an advertisement image selected by the user from among the images displayed in the list is composed in the blank region of the document image and printed onto recording paper; and thus, the user can easily select an advertisement image to be printed onto the recording paper based on the discount rate. In addition, according to the copier of the second mode of embodiment, still lower copying fees can be selected by setting the printing mode of the advertisement image in detail.

Note that, in the first and the second modes of embodiment, the discount rate was shown as a percent in the list image, as shown in FIG. 4 and FIG. 8A; however, without limitation to this, the ratio of the discount rate of each advertisement image, when the maximum discount rate of the advertisement image is defined to be 100, may be displayed, and the ratio may be displayed graphically, such as by a pie graph, a bar graph or the like.

What is claimed is:

1. An image forming device, which collects a printing fee and prints a document image on recording paper, comprising:
a storage means for storing a plurality of add-on images to be printed together with the document image and a discount rate predefined for each of the add-on images;
a display means for displaying a list image that displays the discount rate for each add-on image in a list;
a receiving means for receiving an add-on image selection directive by the user;
a fee calculation means for calculating the printing fee based on the discount rate received by the receiving means; and
a printing means for composing and printing the add-on image indicated by the selection directive and the document image onto the recording paper.

2. The image forming device as recited in claim 1, further comprising: an extraction means for extracting as a blank region a continuous region within the document image where a background portion of no less than a predetermined size is present, and extracting, based on the sizes of the plurality of add-on images stored on the storage means and the size of the blank region, an add-on image that can be displayed within the blank region, wherein:
the display means displays the discount rate for the add-on image extracted by the extraction means, on the list image; and
the printing means composes the add-on image indicated by the selection directive received by the receiving means, in the blank region.

3. The image forming device as recited in claim 2 further comprising:
a printing mode determination means for determining a printing mode of the add-on image onto the recording paper by allowing the user to specify an item condition for each of a predetermined plurality printing items, wherein:
the storage means pre-stores the discount rate for each item condition of each add-on image;
the image forming device further comprises a discount rate calculation means for specifying the discount rate for the item condition specified by the user by referring to the storage means and calculating a discount rate for each add-on image based on the specified discount rate; and
the printing means prints the add-on image onto the recording paper in the printing mode determined by the printing mode determination means.

4. The image forming device as recited in claim 3, wherein the printing items include an item for setting the size of the add-on image, and
the extraction means extracts, based on the size of each add-on image determined by the printing mode determination means and the size of the blank region, an add-on image that can be displayed within the blank region.

5. The image forming device as recited in claim 4, wherein the printing items include color, size, orientation, number and position.

6. The image forming device as recited in claim 4, wherein the storage means further stores a weighting coefficient predefined for each of the printing items, and
the discount rate calculation means calculates the discount rate for each add-on image by multiplying the weighting coefficient by the discount rate for each item condition.

7. The image forming device as recited in claim 1, wherein the display means displays the list image listing the ratio of the discount rate of each add-on image with respect to the maximum discount rate of the add-on image.
